(19) United States
(12) Patent Application Publication
(10) Pub. No.: US 2026/0312019 A1
(43) Pub. Date: Oct. 8, 2026

(54) CATHODE FOR LITHIUM SECONDARY BATTERY AND LITHIUM SECONDARY BATTERY INCLUDING THE SAME

(71) Applicants: SK ON CO., LTD., Seoul (KR); SK INNOVATION CO., LTD., Seoul (KR)

(72) Inventors: Hyo Mi KIM, Daejeon (KR); Sang In BANG, Daejeon (KR); Hyun Ji LEE, Daejeon (KR); Jeong Woo LEE, Daejeon (KR)

(21) Appl. No.: 19/638,130

(22) Filed: Apr. 3, 2026

(30) Foreign Application Priority Data
Apr. 8, 2025 (KR) 10-2025-0045718

(51) Int. Cl. H01M 4/36; H01M 4/02; H01M 4/525; H01M 4/62; H01M 10/0525

(52) U.S. Cl. CPC H01M 4/366; H01M 4/525; H01M 4/625; H01M 2004/021; H01M 10/0525

(57) ABSTRACT

A cathode for a lithium secondary battery includes a cathode current collector, a first cathode active material layer disposed on the cathode current collector and including a first conductive material, and a second cathode active material layer disposed on the first cathode active material layer and including a second conductive material. A Raman R value of the first cathode active material layer is in a range from 0.5 to 1.1, and the Raman R value of the second cathode active material layer is in a range from 1.05 to 1.5.

### CROSS-REFERENCE TO RELATED APPLICATION AND CLAIM OF PRIORITY

This application claims priority to Korean Patent Application No. 10-2025-0045718 filed on Apr. 8, 2025, the entire disclosure of which is incorporated by reference herein.

### TECHNICAL FIELD

Embodiments of the present disclosure relate to a cathode for a lithium secondary battery and a lithium secondary battery including the same. More particularly, embodiments of the present disclosure relate to a cathode for a lithium secondary battery including a conductive material, and a lithium secondary battery including the same.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of eco-friendly vehicle such as an electric vehicle, a hybrid vehicle, etc.

Examples of the secondary battery include a lithium secondary battery, a sodium secondary battery, a potassium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

For example, the lithium secondary battery may include an electrode assembly including a cathode, an anode, and a separation layer (separator), and an electrolyte solution impregnating the electrode assembly. The lithium secondary battery may further include an outer packaging material, e.g., a pouch-shaped packaging material, that accommodates the electrode assembly and the electrolyte solution.

Recently, as an application range of the lithium secondary battery is expanded, demands for high capacity and extended life-span are increasing. For example, the cathode may include a cathode active material containing nickel. The capacity of the lithium secondary battery may be increased by increasing a nickel content in the cathode active material. However, if the nickel content increases, stability and economic feasibility of the cathode active material may be lowered.

### SUMMARY

According to an aspect of the present disclosure, there is provided a cathode for a lithium secondary battery having improved capacity and life-span properties.

According to an aspect of the present disclosure, there is provided a lithium secondary battery having improved capacity and life-span properties.

A cathode for a lithium secondary battery according to embodiments includes a cathode current collector, a first cathode active material layer disposed on the cathode current collector and including a first conductive material, and a second cathode active material layer disposed on the first cathode active material layer and including a second conductive material. A Raman R value according to Equation 1 of the first cathode active material layer is in a range from 0.5 to 1.1, and the Raman R value according to Equation 1 of the second cathode active material layer is in a range from 1.05 to 1.5.

Raman R value=I_{D}/I_{G} [Equation 1]

In Equation 1, I_{D} is a maximum value of a peak intensity measured in a range of 1,350 cm⁻¹ to 1380 cm⁻¹ in a Raman spectrum of the first anode active material layer or the second anode active material layer, and I_{G} is a maximum value of a peak intensity measured in a range of 1,580 cm⁻¹ to 1600 cm⁻¹ in the Raman spectrum of the first anode active material layer or the second anode active material layer.

In some embodiments, the first conductive material may include a point-type conductive material.

In some embodiments, the point-type conductive material may include at least one of graphite, carbon black, acetylene black, or ketjen black.

In some embodiments, a content of the first conductive material may be in a range from 0.5 wt % to 5 wt % based on a total weight of the first cathode active material layer.

In some embodiments, an average particle diameter (D50) of the point-type conductive material may be in a range from 0.01 μm to 4 μm.

In some embodiments, the second conductive material may include a linear-type conductive material.

In some embodiments, the linear-type conductive material may include at least one of a single-walled carbon nanotube (SWCNT) and a multi-walled carbon nanotube (MWCNT).

In some embodiments, a length of the linear-type conductive material may be in a range from 5 μm to 70 μm.

In some embodiments, a content of the second conductive material may be in a range from 0.3 wt % to 1.0 wt % based on a total weight of the second cathode active material layer.

In some embodiments, the first cathode active material layer may include a first lithium-nickel metal oxide in a single particle shape, and the second cathode active material layer may include a second lithium-nickel metal oxide in a single particle shape.

In some embodiments, a mole fraction of nickel among metal elements excluding lithium in each of the first lithium-nickel metal oxide and the second lithium-nickel metal oxide may be in a range from 0.4 to 0.95.

In some embodiments, a difference between the mole fraction of nickel in the first lithium-nickel metal oxide and the mole fraction of nickel in the second lithium-nickel metal oxide may be 0.1 or less.

In some embodiments, at least one of the mole fraction of nickel in the first lithium-nickel metal oxide and the mole fraction of nickel in the second lithium-nickel metal oxide may be 0.6 or less.

In some embodiments, each of the first lithium-nickel metal oxide and the second lithium-nickel metal oxide may include cobalt, and a mole fraction of cobalt among metal elements excluding lithium may be in a range from 0.05 to 0.4.

A lithium secondary battery includes the cathode for a lithium secondary battery according to embodiments of the present disclosure, and an anode opposing the cathode.

A cathode for a lithium secondary battery according to embodiments of the present disclosure may have improved structural stability. A lithium secondary battery including the cathode may provide improved electrical properties and life-span properties.

The cathode for a lithium secondary battery and the lithium secondary battery according to the present disclosure may be widely applied in green technology fields such as an electric vehicle, a battery charging station, a solar power generation, a wind power generation, etc., using a battery, etc. The cathode for a lithium secondary battery and the lithium secondary battery according to the present disclosure may be used for eco-friendly electric vehicles and hybrid vehicles to prevent a climate change by suppressing air pollution and greenhouse gas emissions. etc.

### BRIEF DESCRIPTION OF THE DRAWINGS

FIG. 1 is a schematic cross-sectional view illustrating a cathode for a lithium secondary battery in accordance with example embodiments.

FIGS. 2 and 3 are a schematic cross-sectional view and a plan view, respectively, illustrating a lithium secondary battery in accordance with example embodiments.

### DETAILED DESCRIPTION OF THE EMBODIMENTS

According to embodiments of the present disclosure, a cathode for a lithium secondary battery (hereinafter, that may be abbreviated as a cathode) including a first cathode active material layer and a second cathode active material layer that include a first conductive material and a second conductive material, respectively. Further, according to embodiments of the present disclosure, a lithium secondary battery (hereinafter, that may be abbreviated as a secondary battery) including the cathode active material for a lithium secondary battery is provided.

Hereinafter, embodiments of the present disclosure will be described in detail. However, disclosed embodiments are merely provided as examples and the present disclosure is not limited to the specific embodiments.

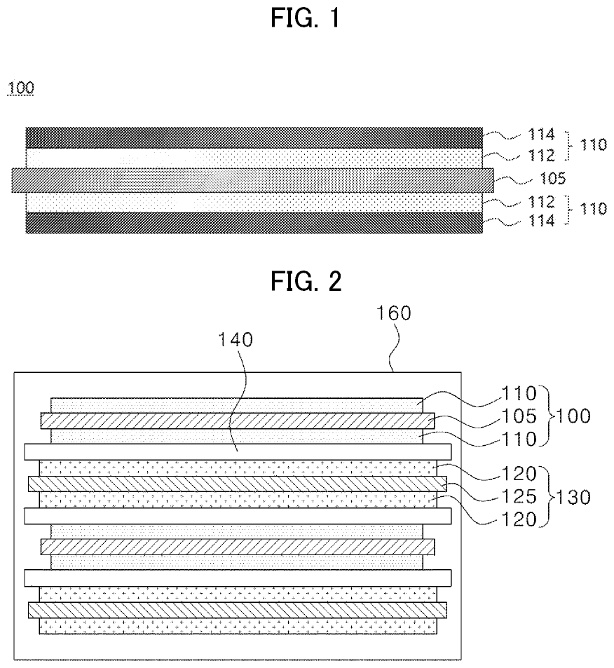

FIG. 1 is a schematic cross-sectional view illustrating a cathode for a lithium secondary battery according to example embodiments.

Referring to FIG. 1, a cathode 100 may include a cathode active material layer 110 disposed on at least one surface of a cathode current collector 105. The cathode active material layer 110 may include a first cathode active material layer 112 and a second cathode active material layer 114.

For example, the cathode active material layer 110 may be formed from a cathode slurry that may be prepared by dispersing lithium-metal oxide particles and a conductive material in a solvent. For example, the cathode slurry may be coated on the cathode current collector 105, and then dried and pressed to obtain the cathode 100.

For example, the first cathode active material layer 112 and the second cathode active material layer 114 may be sequentially formed on the cathode current collector 105. For example, a first cathode slurry may be prepared by dissolving a cathode active material and a first conductive material in a solvent, and the first cathode slurry may be coated on the cathode current collector 105 to form a first preliminary cathode active material layer.

A cathode active material and a second conductive material may be dissolved in a solvent to prepare a second cathode slurry. The second cathode slurry may be coated on the first preliminary cathode active material layer. Thereafter, the first preliminary cathode active material layer and the second preliminary cathode active material layer may be dried and pressed to prepare the first cathode active material layer 112 and the second cathode active material layer 114.

The first cathode active material layer 112 may be disposed on the cathode current collector 105. The first cathode active material layer 112 may be in contact with an upper surface of the cathode current collector 105. For example, the first cathode active material layer 112 may be disposed on both surfaces of the cathode current collector 105.

The second cathode active material layer 114 may be disposed on the first cathode active material layer 112. For example, the second cathode active material layer 114 may be in contact with an upper surface of the first cathode active material layer 112 opposing the cathode current collector 105.

In example embodiments, a Raman R value of the first cathode active material layer 112 according to Equation 1 below may be in a range from 0.5 to 1.1.

Raman R Value=I_{D}/I_{G} [Equation 1]

In Equation 1, I_{D} is a maximum value of a peak intensity measured in a range of 1,350 cm⁻¹ to 1380 cm⁻¹ in a Raman spectrum of the first cathode active material layer or the second cathode active material layer. I_{G} is a maximum value of a peak intensity measured in a range of 1,580 cm⁻¹ to 1600 cm⁻¹ in a Raman spectrum of the first cathode active material layer or the second cathode active material layer.

The Raman spectrum may be obtained from an arithmetic average value of values obtained by designating 100 or more, 200 or more, or 500 or more arbitrary points for the first anode active material layer or the second anode active material layer and performing a Raman spectroscopy analysis for each point. As the number of measurement points increases, accuracy and reliability of measurement may be enhanced.

In one embodiment, the Raman spectroscopic analysis may be performed using a Raman spectroscopic analysis device (e.g., inVia manufactured from Renishaw) under conditions of a 532 nm wavelength laser, a 1 μm spot size, 0.5-20 mW power, room temperature and atmospheric atmosphere.

In some embodiments, the Raman R value of the first cathode active material layer 112 according to Equation 1 may be 0.55 or more, 0.6 or more, 0.65 or more, 0.7 or more, 0.75 or more, 0.8 or more, 0.85 or more, 0.88 or more, 0.89 or more, or 0.90 or more.

In some embodiments, the Raman R value of the first cathode active material layer 112 according to Equation 1 may be 1.09 or less, 1.08 or less, 1.07 or less, 1.06 or less, 1.05 or less, 1.04 or less, 1.03 or less, 1.02 or less, 1.01 or less, or 1.00 or less.

The Raman R value of the first cathode active material layer 112 according to Equation 1 may be in a range from 0.55 to 1.09, from 0.6 to 1.08, from 0.65 to 1.07, from 0.7 to 1.06, from 0.75 to 1.05, from 0.8 to 1.04, from 0.85 to 1.05, from 0.88 to 1.04, from 0.89 to 1.03, from 0.9 to 1.02, from 0.9 to 1.01, or from 0.9 to 1.00.

The first anode active material layer 112 having the Raman R value in the above range may improve electrical conductivity and life-span properties of the secondary battery. For example, when the Raman R value of the first anode active material layer 112 exceeds the above range, an electrical conductivity of the first anode active material layer 112 may be reduced.

For example, when the Raman R value of the first anode active material layer above 112 is less than the above range, cracks in the cathode active material in the form of a single particle may be accelerated. Accordingly, the life-span properties of the secondary battery may be degraded.

In example embodiments, the Raman R value of the second cathode active material layer 114 according to Equation 1 may be in a range from 1.05 to 1.5.

In some embodiments, the Raman R value of the second cathode active material layer 114 according to Equation 1 may be 1.06 or more, 1.07 or more, 1.08 or more, 1.09 or more, 1.10 or more, 1.11 or more, 1.12 or more, 1.13 or more, or 1.14 or more.

In some embodiments, the Raman R value of the second cathode active material layer 114 according to Equation 1 may be 1.49 or less, 1.48 or less, 1.47 or less, 1.46 or less, 1.45 or less, 1.44 or less, 1.43 or less, 1.42 or less, 1.41 or less, or 1.40 or less.

For example, the Raman R value according to Equation 1 of the second cathode active material layer 114 may be in a range from 1.06 to 1.49, from 1.07 to 1.48, from 1.08 to 1.47, from 1.09 to 1.46, from 1.10 to 1.45, from 1.11 to 1.44, from 1.12 to 1.43, from 1.13 to 1.42, from 1.14 to 1.41, or from 1.14 to 1.40.

The second cathode active material layer 114 having the Raman R value within the above range may reduce a resistance of the secondary battery and improve stability of the cathode active material. For example, if the Raman R value of the second cathode active material layer 114 exceeds the above range, the resistance of the second cathode active material layer 114 may be increased.

For example, if the Raman R value of the second cathode active material layer 114 is below the above range, particle breakage of the cathode active material may occur during charging/discharging or pressing. Accordingly, life-span properties of the secondary battery may be degraded.

For example, an upper layer and a lower layer of the electrode may be separated, and the Raman R value may be measured for each layer by the Raman spectroscopic spectrum. For example, in the case of the cathode, the first cathode active material layer and the second cathode active material layer may be separated, and the Raman R value may be obtained by measuring the Raman spectrum for each layer.

The Raman R value may be obtained by individually preparing electrodes having the same composition as that of the upper layer and the lower layer of the electrode, and then measuring the Raman spectrum for each prepared layer. For example, an electrode having the same composition as that of the first cathode active material layer in the cathode, and an electrode having the same composition as that of the second cathode active material layer in the cathode may each be prepared, and then the Raman spectrum may be obtained from each of the electrodes to calculate the Raman R value.

The cathode slurry may further include a binder, and optionally may further include a thickener.

The binder may include, e.g., an organic binder such as vinylidene fluoride-hexafluoropropylene copolymer (PVDF-co-HFP), polyvinylidenefluoride (PVDF), polyacrylonitrile, polymethylmethacrylate, etc., or an aqueous binder such as styrene-butadiene rubber (SBR), and may be used together with a thickener such as carboxymethyl cellulose (CMC).

For example, a PVDF-based binder may be used as the cathode binder. For example, a content of the binder may be adjusted according to a content of a conductive material.

The cathode current collector 105 may include stainless steel, nickel, aluminum, titanium, copper, or an alloy thereof. The cathode current collector 105 may include aluminum or stainless steel surface-treated with carbon, nickel, titanium, copper, or silver. For example, a thickness of the cathode current collector 105 may be in a range from 5 μm to 50 μm.

In example embodiments, the first cathode active material layer 112 may include a first cathode active material. In example embodiments, the second cathode active material layer 114 may include a second cathode active material.

Compositions of the first cathode active material and the second cathode active material may be the same as or different from each other. The first cathode active material and the second cathode active material may include a compound capable of reversibly intercalating and de-intercalating lithium ions.

The first cathode active material and the second cathode active material may comprise a lithium-nickel metal oxide. The lithium-nickel metal oxide may further comprise at least one of cobalt (Co), manganese (Mn), and aluminum (Al).

The lithium-nickel metal oxide may include a layered structure or a crystal structure represented by Chemical Formula 1 below.

LiₓNiₐM_{b}O_{2+z} [Chemical Formula 1]

In Chemical Formula 1, 0.9≤x≤1.2, 0.3≤a≤0.99, 0.01≤b≤0.4, and −0.5≤z≤0.1. M may include Co, Mn and/or Al.

The chemical structure represented by Chemical Formula 1 may represent bonding relationship included in the layered structure or the crystal structure included in the cathode active material, and does not exclude other additional elements. For example, in Chemical Formula 1, M may include Co and/or Mn, and Co and/or Mn may serve as main active element of the cathode active material together with Ni. Chemical Formula 1 is provided to express the bonding relationship of the main active elements, and is to be understood as a formula encompassing introduction and substitution of the additional elements.

In an embodiment, an auxiliary element may be further included in addition to the main active elements to enhance chemical stability of the cathode active material or a layered/crystal structure. The auxiliary element may be incorporated in the layered structure/crystal structure to form a bond, and this case is to be understood as being included in the structure represented by Chemical Formula 1.

For example, the auxiliary element may include at least one selected from the group consisting of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al which may contribute to capacity/power activity of the cathode active material together with Co or Mn.

In example embodiments, the lithium-nickel metal oxide may include nickel, cobalt and manganese. For example, cobalt and/or manganese may be provided as the main active element of the lithium-nickel metal oxide together with nickel.

The first cathode active material and the second cathode active material may include a first lithium-nickel metal oxide and a second lithium-nickel metal oxide, respectively, having the same or different compositions. For example, mole fractions of nickel among metals excluding lithium in the first lithium-nickel metal oxide and the second lithium-nickel oxide may be the same or different.

The term “mole fraction of metal A” as used herein refers to a mole fraction of metal A among elements excluding lithium and oxygen in the cathode active material. For example, if the cathode active material further includes a dopant, the term “mole fraction of metal A” may refer to a mole fraction of metal A among elements excluding lithium and oxygen from total elements including the dopant.

In example embodiments, a mole fraction of nickel in the first lithium-nickel metal oxide and a mole fraction of nickel in the second lithium-nickel metal oxide may be 0.4 or more, 0.41 or more, 0.42 or more, 0.45 or more, 0.48 or more, or 0.5 or more.

In example embodiments, the mole fraction of nickel in the first lithium-nickel metal oxide and the mole fraction of nickel in the second lithium-nickel metal oxide may be 0.99 or less, 0.98 or less, 0.97 or less, 0.96 or less, 0.95 or less, 0.93 or less, 0.92 or less, 0.91 or less, or 0.90 or less.

For example, the mole fraction of nickel in the first lithium-nickel metal oxide and the mole fraction of nickel in the second lithium-nickel metal oxide may be in a range from 0.4 to 0.99, from 0.4 to 0.95, from 0.41 to 0.95, from 0.42 to 0.95, from 0.45 to 0.95, from 0.48 to 0.93, or from 0.5 to 0.90.

In the nickel content range, a secondary battery having improved capacity and energy density may be efficiently implemented.

In example embodiments, the mole fractions of nickel in the first lithium-nickel metal oxide and the second lithium-nickel metal oxide may be the same as or different from each other.

In example embodiments, a difference between the mole fraction of nickel in the first lithium-nickel metal oxide and the mole fraction of nickel in the second lithium-nickel metal oxide may be 0.1 or less, 0.05 or less, 0.03 or less, or 0.01 or less. In an embodiment, the mole fraction of nickel in the first lithium-nickel metal oxide and the mole fraction of nickel in the second lithium-nickel metal oxide may be substantially the same.

A conductive material described below may be included in the first cathode active material layer 112 and the second cathode active material layer 114 having similar mole fractions of nickel, so that a cathode having improved conductivity may be implemented, and a secondary battery having improved capacity and energy density may be implemented.

In some embodiments, at least one of the mole fraction of nickel in the first lithium-nickel metal oxide and the mole fraction of nickel in the second lithium-nickel metal oxide may be 0.8 or less.

In some embodiments, at least one of the mole fraction of nickel in the first lithium-nickel metal oxide and the mole fraction of nickel in the second lithium-nickel metal oxide may be 0.4 or more, 0.41 or more, 0.42 or more, 0.43 or more, 0.44 or more, or 0.45 or more.

In some embodiments, at least one of the mole fraction of nickel in the first lithium-nickel metal oxide and the mole fraction of nickel in the second lithium-nickel metal oxide may be 0.75 or less, 0.7 or less, 0.65 or less, 0.62 or less, or 0.6 or less.

For example, at least one of the mole fraction of nickel in the first lithium-nickel metal oxide and the mole fraction of nickel in the second lithium-nickel metal oxide may be in a range from 0.4 to 0.75, from 0.42 to 0.75, from 0.43 to 0.7, from 0.44 to 0.65, or from 0.45 to 0.6.

The lithium-nickel metal oxide having the above range of the nickel mole fraction may improve structural stability of the cathode active material layer 110. Accordingly, life-span properties of the secondary battery may be improved.

In example embodiments, the first lithium-nickel metal oxide and the second lithium-nickel metal oxide may contain cobalt.

In example embodiments, a mole fraction of cobalt in the first lithium-nickel metal oxide and a mole fraction of cobalt in the second lithium-nickel metal oxide may be 0.4 or less, 0.35 or less, 0.3 or less, 0.25 or less, 0.22 or less, or 0.2 or less.

In example embodiments, the mole fraction of cobalt in the first lithium-nickel metal oxide and the mole fraction of cobalt in the second lithium-nickel metal oxide may be 0.05 or more, 0.06 or more, 0.07 or more, 0.08 or more, 0.09 or more, or 0.10 or more.

For example, the mole fraction of cobalt in the first lithium-nickel metal oxide and the mole fraction of cobalt in the second lithium-nickel metal oxide may be in a range from 0.05 to 0.4, from 0.07 to 0.35, from 0.08 to 0.3, from 0.09 to 0.25, or from 0.10 to 0.20.

In the above cobalt content range, conductivity and resistance properties of the secondary battery may be improved. In example embodiments, the mole fraction of cobalt in the first lithium-nickel metal oxide and the mole fraction of cobalt in the second lithium-nickel metal oxide may be the same as or different from each other.

The mole fraction of cobalt in the lithium-nickel metal oxide may vary depending on the mole fraction of nickel. For example, if the mole fraction of nickel increases, the mole fraction of cobalt may decrease.

In example embodiments, the first lithium-nickel metal oxide and the second lithium-nickel metal oxide may contain manganese.

In the first lithium-nickel metal oxide and the second lithium-nickel metal oxide, manganese may be provided as a metal related to mechanical and electrical stability of the secondary battery.

In example embodiments, the first lithium-nickel metal oxide may have a single particle shape.

In example embodiments, the second lithium-nickel metal oxide may have a single particle shape.

For example, the first lithium-metal oxide and the second lithium-metal oxide may have a granular or spherical single particle shape.

Cracks during charging and discharging may be reduced in the lithium-nickel metal oxide having the single particle shape, so that the life-span properties of secondary battery may be improved.

The term “single particle shape” herein may be used to exclude, e.g., a secondary particle formed by aggregation of multiple primary particles. For example, in the first lithium-metal oxide, the secondary particle formed substantially as one particle by assemble or aggregation of the primary particles (e.g., more than 10, 20 or more, 30 or more, 40 or more, 50 or more, etc., of the primary particles) may be excluded. However, the single particle shape may not exclude a shape where 2 to 10 single particles are attached or adjacent to each other to form a substantially monolithic shape (e.g., a structure converted into a single particle).

For example, a boundary of the primary particles that are observed in the secondary particle may not be observed in an SEM cross-sectional image of in the single particle.

For example, the secondary particle may refer to a particle in which multiple primary particles are aggregated to be considered or observed as substantially one particle. For example, the boundary of the primary particles may be observed in an SEM cross-sectional image of the secondary particle.

For example, the secondary particle may include more than 10, 30 or more, 50 or more, or 100 or more primary particles aggregated therein.

Fine particles (e.g., particles having a volume of 1/100 or less relative to a volume of the single particle) may be attached to a surface of the single particle, and this structure is not excluded from the concept of the single particle.

In example embodiments, an average particle size (D50) of the first lithium-metal oxide and the second lithium-metal oxide may be in a range from 1 μm to 20 μm, from 1.5 μm to 18 μm, from 2 μm to 15 μm, or from 3 μm to 12 μm.

As used herein, the terms “average particle size,” “D50,” or “average particle size (D50)” may refer to a particle size at which a volume-based cumulative percentage in a particle size distribution obtained based on volumes of particles corresponds to 50%. For example, the average particle size may be measured using a laser diffraction method (microtrac MT 3000).

In example embodiments, a content of the first conductive material may be in a range from 0.5 wt % to 5 wt % based on a total weight of the first cathode active material layer 112.

In some embodiments, the content of the first conductive material may be 0.8 wt % or more, 1.0 wt % or more, 1.2 wt % or more, 1.5 wt % or more, 1.8 wt % or more, or 2.0 wt % or more based on the total weight of the first cathode active material layer 112.

In some embodiments, the content of the first conductive material may be 4.8 wt % or less, 4.7 wt % or less, 4.5 wt % or less, 4.4 wt % or less, 4.2 wt % or less, or 4.0 wt % or less based on the total weight of the first cathode active material layer 112.

For example, the content of the first conductive material may be in a range from 0.8 wt % to 4.8 wt %, from 1.0 wt % to 4.5 wt %, from 1.5 wt % to 4.2 wt %, or from 2.0 wt % to 4.0 wt % based on the total weight of the first cathode active material layer 112.

The first conductive material included in the above content range may further promote electron transfer. Accordingly, an energy density of the secondary battery may be maintained or improved even when the nickel content included in the first cathode active material layer 112 and/or the second cathode active material layer 114 is reduced.

In example embodiments, the first conductive material may include a point-type conductive material.

The point-type conductive material may represent a conductive material having an aspect ratio of less than or equal to a certain value. For example, the aspect ratio (length/diameter) of the point-type conductive material may be 2.0 or less, 1.5 or less, or 1.3 or less. A shape of the point-type conductive material may include a sphere shape, an ellipse shape, etc.

The point-type conductive material may include a graphite-based conductive material, a carbon black-based conductive material, a metal-based conductive material, etc.

For example, the graphite-based conductive material may include artificial graphite, natural graphite, etc. For example, the carbon black-based conductive material may include acetylene black, Ketjen black, furnace black, lamp black, etc. The metal-based conductive material may include an aluminum powder, a nickel powder, titanium oxide, tin, tin oxide, LaSrCoO₃, LaSrMnO₃, etc.

In example embodiments, the point-type conductive material may include at least one of graphite, carbon black, acetylene black or ketjen black.

In some embodiments, the first conductive material may include a graphite-based conductive material.

In example embodiments, the graphite-based conductive material may include at least one of artificial graphite or natural graphite.

The graphite-based conductive material may be included in the first cathode active material layer 112 adjacent to the cathode current collector 105 to improve electrical conductivity of the cathode 100.

In example embodiments, the point-type conductive material may have an average particle diameter (D50) of 0.01 μm or more, 0.03 μm or more, 0.05 μm or more, 0.08 μm or more, 0.1 μm or more, 0.15 μm or more, or 0.2 μm or more.

In example embodiments, the point-type conductive material may have an average particle diameter (D50) of 4 μm or less, 3.5 μm or less, 3.2 μm or less, 3.0 μm or less, 2.8 μm or less, 2.6 μm or less, or 2.5 μm or less.

For example, the point-type conductive material may have an average particle diameter (D50) in a range from 0.01 μm to 4 μm, from 0.05 μm to 3.5 μm, from 0.08 μm to 3.2 μm, from 0.1 μm to 3.0 μm, from 0.15 μm to 2.8 μm, or from 0.2 μm to 2.5 μm.

The point-type conductive material having the particle diameter in the above range may form a comprehensive conductive network together with the second conductive material to improve the electrical conductivity of the secondary battery.

In some embodiments, the first conductive material may include both artificial graphite and natural graphite. For example, a particle diameter and a content of each of the artificial graphite and natural graphite included in the first conductive material may be controlled.

In some embodiments, the first conductive material may include both artificial graphite and natural graphite, and a content of artificial graphite based on a total weight of the first conductive material may be in a range from 60 wt % to 95 wt %, from 65 wt % to 90 wt %, or from 70 wt % to 90 wt %.

A content of natural graphite based on the total weight of the first conductive material may be a remainder excluding the content of the artificial graphite.

In some embodiments, the first conductive material may include artificial graphite having an average particle diameter from 0.01 μm to 4 μm, from 0.05 μm to 3.5 μm, from 0.1 μm to 3.0 μm, from 0.15 μm to 2.8 μm, or from 0.2 μm to 2.5 μm, and natural graphite having an average particle diameter from 0.01 μm to 4 μm, from 0.05 μm to 3.5 μm, from 0.1 μm to 3.0 μm, from 0.15 μm to 2.8 μm, or from 0.2 μm to 2.5 μm.

The Raman R value according to Equation 1 of the first cathode active material layer 112 including artificial graphite and natural graphite in the particle diameter and content range may be included in a predetermined numerical range. Accordingly, the electrical conductivity and the life-span properties of the secondary battery may both be improved.

In example embodiments, a content of the second conductive material based on the total weight of the second cathode active material layer 114 may be less than a content of the first conductive material based on the total weight of the first cathode active material layer 112.

In example embodiments, the content of the second conductive material may be in a range from 0.3 wt % to 1.0 wt % based on the total weight of the second cathode active material layer 114.

In some embodiments, the content of the second conductive material may be in a range from 0.33 wt % or more, 0.35 wt % or more, 0.37 wt % or more, 0.38 wt % or more, 0.39 wt % or more, or 0.40 wt % or more based on the total weight of the second cathode active material layer 114.

In some embodiments, the content of the second conductive material may be 0.9 wt % or less, 0.87 wt % or less, 0.85 wt % or less, 0.83 wt % or less, 0.82 wt % or less, or 0.80 wt % or less based on the total weight of the second cathode active material layer 114.

For example, the content of the second conductive material may be in a range from 0.33 wt % to 0.9 wt %, from 0.35 wt % to 0.87 wt %, from 0.37 wt % to 0.85 wt %, from 0.38 wt % to 0.83 wt %, from 0.39 wt % to 0.82 wt %, or from 0.40 wt % to 0.80 wt % based on the total weight of the second cathode active material layer 114.

In the above content range, mobility of electrons promoted by the first conductive material may be maintained. Accordingly, capacity and initial charge/discharge properties of the secondary battery may be improved.

In example embodiments, the second conductive material may include a linear-type conductive material.

The linear-type conductive material may refer to a conductive material having an aspect ratio greater than or equal to a predetermined value. For example, an aspect ratio (length/diameter) of the linear-type conductive material may be greater than 1.5, 2.0 or more, or 2.5 or more. The linear-type conductive material may have a needle shape.

The linear-type conductive material may include a carbon nanotube (CNT)-based conductive material, a carbon nanofiber, graphene, etc.

For example, the carbon nanotube-based conductive material may include a single-walled carbon nanotubes (SWCNT), a double-walled carbon nanotubes (DWCNT), a multi-walled carbon nanotubes (MWCNT), etc.

In example embodiments, the second conductive material may include the CNT-based conductive material.

In example embodiments, the CNT-based conductive material may include at least one of SWCNT or MWCNT.

The CNT-based conductive material may form a wide conductive network in the second cathode active material layer 114 to reduce a resistance of the cathode 100.

In example embodiments, a length of the linear-type conductive material may be 5 μm or more, 7 μm or more, 10 μm or more, 12 μm or more, 14 μm or more, 15 μm or more, 16 μm or more, 17 μm or more, 18 μm or more, 19 μm or more, or 20 μm or more.

In example embodiments, the length of the linear-type conductive material may be 70 μm or less, 65 μm or less, 62 μm or less, 60 μm or less, 58 μm or less, 55 μm or less, 53 μm or less, 52 μm or less, 51 μm or less, or 50 μm or less.

For example, the linear-type conductive material may have a length in a range from m to 70 μm, from 10 μm to 65 μm, from 12 μm to 60 μm, from 15 μm to 58 μm, from 16 μm to 55 μm, from 18 μm to 52 μm, or from 20 μm to 50 μm.

Voids may be formed in the conductive network by the linear-type conductive material having the length range. Accordingly, electron transfer may be promoted.

In some embodiments, the second conductive material may include both SWCNT and MWCNT. For example, a length and a content of each of SWCNT and MWCNT included in the second conductive material may be controlled.

In some embodiments, the second conductive material may include both SWCNT and MWCNT, and the content of MWCNT based on the total weight of the second conductive material may be in a range from 80 wt % to 99 wt %, from 82 wt % to 98 wt %, or from 85 wt % to 97 wt %.

The second anode active material layer including MWCNT in the above content range may satisfy the Raman R value according to Equation 1. Accordingly, the capacity and life-span properties of the secondary battery may be improved together.

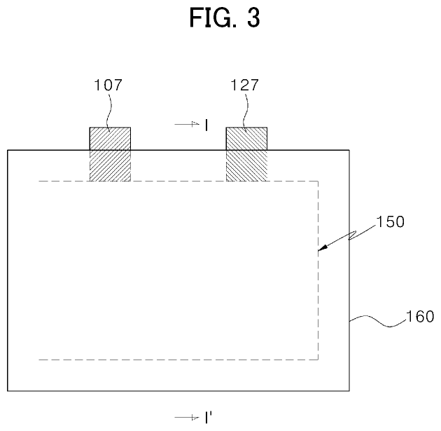

FIGS. 2 and 3 are a schematic cross-sectional view and a plan view, respectively, illustrating a lithium secondary battery according to embodiments. For example, FIG. 2 is a cross-sectional view taken along a line I-I′ of FIG. 3 in a thickness direction.

Referring to FIGS. 2 and 3, the lithium secondary battery may include a cathode 100 according to the above-described embodiments and an anode 130 opposing the cathode 100.

The anode 130 may include an anode current collector 125 and an anode active material layer 120 disposed on at least one surface of the anode current collector 125.

For example, the anode current collector 125 may include a copper foil, a nickel foil, a stainless steel foil, a titanium foil, a nickel foam, a copper foam, a polymer substrate coated with a conductive metal, or the like. These may be used alone or in a combination of two or more thereof. For example, a thickness of the anode current collector 125 may in a range from 10 μm to 50 μm.

The anode active material layer 120 may include an anode active material. The anode active material may include a material capable of intercalating and de-intercalating lithium ions. For example, a carbon-based material such as a crystalline carbon, an amorphous carbon, a carbon composite, a carbon fiber, etc.; a lithium alloy; a silicon-containing material; or tin, etc., may be used.

Examples of the amorphous carbon include hard carbon, coke, a mesocarbon microbead (MCMB) fired at 1,500° C. or less, a mesophase pitch-based carbon fiber (MPCF), or the like. Examples of the crystalline carbon may include a graphite-based carbon such as natural graphite, a graphitized coke, a graphitized MCMB, a graphitized MPCF, or the like.

An element included in the lithium alloy may include aluminum, zinc, bismuth, cadmium, antimony, silicon, lead, tin, gallium, or indium.

The silicon-containing material may provide more increased capacity properties.

The silicon-containing material may include Si, SiOx (0<x<2), a metal-doped SiOx (0<x<2), a silicon-carbon composite, or the like. The metal may include lithium and/or magnesium, and the metal-doped SiOx (0<x<2) may include a metal silicate.

In some embodiments, an anode slurry may be prepared by mixing and stirring the anode active material with a binder, a conductive material, and/or a dispersant in a solvent. The anode slurry may be coated on the anode current collector, and then dried and pressed to prepare the anode 130.

Materials substantially the same as or similar to the above-described materials may be used as the binder and the conductive material. In some embodiments, the binder for forming the anode may include an aqueous binder such as styrene-butadiene rubber (SBR) for compatibility with the carbon-based active material, and may be used together with a thickener such as carboxymethyl cellulose (CMC).

In some embodiments, a separator 140 may be interposed between the cathode 100 and the anode 130. The separator 140 may include a porous polymer film formed of a polyolefin-based polymer such as an ethylene homopolymer, a propylene homopolymer, an ethylene/butene copolymer, an ethylene/hexene copolymer, an ethylene/methacrylate copolymer, etc. The separator 140 may also include a nonwoven fabric formed of a high-melting-point glass fiber, a polyethylene terephthalate fiber, etc.

In example embodiments, an electrode cell may be defined by the cathode 100, the anode 130 and the separator 140, and a plurality of the electrode cells may be stacked to form, an electrode assembly 150 in the form of, e.g., a jelly roll. For example, the electrode assembly 150 may be formed by winding, stacking, zigzag-folding, stack-folding, etc., of the separator 140.

The electrode assembly may be housed together with an electrolyte in a case 160 to define a lithium secondary battery. In example embodiments, a non-aqueous electrolyte solution may be used as the electrolyte solution.

The non-aqueous electrolyte solution may include a lithium salt as an electrolyte and an organic solvent. The lithium salt may be represented, e.g., as Li⁺X⁻, and the anion (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include, e.g., propylene carbonate (PC), ethylene carbonate (EC), butylene carbonate, Diethyl carbonate (DEC), dimethyl carbonate (DMC), ethylmethyl carbonate (EMC), methylpropyl carbonate, ethylpropyl carbonate, dipropyl carbonate, vinylene carbonate, methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, propylene sulfite, etc. These may be used alone or in combination of two or more therefrom.

The non-aqueous electrolyte solution may further include an additive. The additive may include, e.g., a cyclic carbonate compound, a fluorine-substituted carbonate compound, a sultone compound, a cyclic sulfate compound, a cyclic sulfite compound, a phosphate compound, a borate compound, etc. These may be used alone or in a combination of two or more therefrom.

The cyclic carbonate compound may include vinylene carbonate (VC), vinyl ethylene carbonate (VEC), etc.

The fluorine-substituted cyclic carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis-oxalato phosphate, lithium difluoro phosphate, etc.

The borate compound may include lithium bis(oxalato) borate, etc.

In some embodiments, a solid electrolyte may be used instead of the above-described non-aqueous electrolyte solution. In this case, the lithium secondary battery may be fabricated in the form of an all-solid-state battery. Additionally, a solid electrolyte layer may be disposed between the cathode 100 and the anode 130 instead of the above-described separator 140.

The solid electrolyte may include a sulfide-based electrolyte. Non-limiting examples of the sulfide-based electrolyte include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂-LiₚMO_{q}, (p and q are positive numbers, M is P, Si, Ge, B, Al, Ga or In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), or the like. These may be used alone or in a combination of two or more therefrom.

In an embodiment, the solid electrolyte may include, e.g., an oxide-based amorphous solid electrolyte such as Li₂O—B₂O₃—P₂O₅, Li₂O—SiO₂, Li₂O—B₂O₃, Li₂O—B₂O₃—ZnO, etc.

As illustrated in FIG. 3, electrode tabs (a cathode tab and an anode tab) may protrude from a cathode current collector 105 and an anode current collector 125 included in each electrode cell to extend to one side of the case 160. The electrode tabs may be fused together with the one side portion of the case 160 to form an electrode lead (a cathode lead 107 and an anode lead 127) that may be extended or exposed to an outside of the case 160.

For example, the lithium secondary battery may be fabricated in a cylindrical type using a can, a prismatic type, a pouch type, or a coin type.

Hereinafter, embodiments of the present disclosure will be further described with reference to specific experimental examples. The embodiments and comparative examples included in the experimental examples are only for illustrating the present disclosure and are not intended to limit the appended claims, and it is clear to those skilled in the art that various changes and modifications can be made to the embodiments within the scope and technical spirit of the present disclosure, and it is also natural that such variations and modifications belong to the appended claims.

### EXPERIMENTAL EXAMPLE

### Preparation of Conductive Material

Samples of a first conductive material (point-type conductive material) containing a carbon-based conductive material (average particle diameter (D50): about 2 μm) according to Table 1 below and samples of a second conductive material (linear-type conductive material) including a CNT-based conductive material containing a multi-walled carbon nanotube (MWCNT; length: about 30 μm) according to Table 2 below were each analyzed by a Raman spectroscopy to obtain a Raman spectrum.

Raman R values were calculated according to Equation 2 below, and the calculation results were shown in Tables 1 and 2 below. The measurement equipment/conditions are as follows.

A graphite-based conductive material used as the second conductive material of Comparative Example 9 as shown in Table 3 had a Raman R value of 0.91, and the CNT-based conductive material used as the first conductive material of Comparative Example 10 had a Raman R value of 1.20.

$$Raman R Value = {I}_{D 2} / {I}_{G 2} \qquad [ Equation 2 ]$$

In Equation 2, I_{D2} is a maximum value of a peak intensity measured in a range of 1,350 cm⁻¹ to 1380 cm⁻¹ in the Raman spectrum of the first conductive material or the second conductive material, and I_{G2} is a maximum value of a peak intensity measured in the range of 1,580 cm⁻¹ to 1600 cm⁻¹ in the Raman spectrum of the first conductive material or the second conductive material.
i) Raman spectroscopy: inVia Raman Microscope, Renishaw (UK)
ii) Laser focus level: 40%
iii) Argon ion laser light wavelength: 532 nm
iv) Exposure time: 10 seconds, mapping count: 10 times
v) Scale: ×20
vi) Laser power: 100%, 12 mV

TABLE 1

| | True density | BET | Raman R value of first |
|---|---|---|---|
| | (g/cm³) | (m²/g) | conductive material |
| Sample 1 | 1.830 | 60.0 | 0.91 |
| Sample 2 | 1.950 | 254.0 | 0.92 |
| Sample 3 | 1.950 | 133.0 | 1.04 |
| Sample 4 | 1.950 | 62.0 | 0.16 |
| Sample 5 | 2.250 | 18.7 | 1.13 |

TABLE 2

| | True density | BET | Raman R value of second |
|---|---|---|---|
| | (g/cm³) | (m²/g) | conductive material |
| Sample 6 | 2.040 | 222.0 | 1.20 |
| Sample 7 | 1.950 | 290.0 | 1.15 |
| Sample 8 | 1.040 | 222.0 | 1.14 |
| Sample 9 | 1.950 | 330.0 | 1.6 |
| Sample 10 | 2.93 | 240.0 | 0.85 |

### EXAMPLES AND COMPARATIVE EXAMPLES

### Example 1

### (1) Preparation of Cathode

### 1) Preparation of First Cathode Slurry

Lithium-nickel metal oxide (Li[Ni_{0.88}Co_{0.1}Mn_{0.02}]O₂) having a single particle shape of an average particle size of 3.8 μm was used as a cathode active material. The first conductive material (point-type conductive material) according to Sample 1 was used as a conductive material, and polyvinylidene fluoride (PVDF) was used as the binder. A first cathode slurry was prepared by dissolving the cathode active material, the first conductive material and the binder in an organic solvent in a weight ratio of 96.0:3.0:1.0.

### 2) Preparation of Second Cathode Slurry

Lithium-nickel metal oxide (Li[Ni_{0.88}Co_{0.1}Mn_{0.02}]O₂) having a single-particle shape of an average particle size of 3.8 μm was used as a cathode active material. A second conductive material (linear-type conductive material) according to Sample 6 was used as the conductive material, and PVDF was used as the binder. The cathode active material, the second conductive material and the binder were dissolved in an organic solvent in a weight ratio of 98.5:0.5:1.0 to prepare a second cathode slurry.

### 3) Preparation of Cathode

The first cathode slurry was uniformly coated on an aluminum foil having a thickness of 12 μm to form a first cathode active material layer, and the second cathode slurry was coated on the first anode active material layer to form a second cathode active material layer. Subsequently, drying and pressing were performed to form a cathode in which the first cathode active material layer and the second cathode active material layer were sequentially stacked on the cathode current collector.

### (2) Preparation of Anode

A first anode slurry containing artificial graphite as a first carbon-based active material, Si/C as a silicon-based active material, SBR (styrene-butadiene rubber) as a binder, carboxymethyl cellulose as a thickener and the first conductive material in a weight ratio of 90.1:8:1.2:0.6:0.1 was prepared.

A second anode containing artificial graphite as a second carbon-based active material, Si/C (silicon-carbon composite) as a silicon-based active material, SBR as a binder and the second conductive material in a weight ratio of 89.2:8:1.2:1.5:0.1 was prepared.

Thereafter, the first anode slurry was coated on a copper foil serving as an anode current collector to form a first anode active material layer, and the second anode slurry was coated on the first anode active material layer to form a second anode active material layer. Subsequently, drying at 80° C. and pressing were performed to form an anode. A loading weight (LW) ratio of the first anode active material layer and the second anode active material layer was 5:5.

### (3) Fabrication of Secondary Battery

The cathode and the anode were each notched to a predetermined size, and stacked with a separator (polyethylene, thickness: 15 μm) interposed therebetween to form an electrode assembly.

The electrode assembly was placed in a coin-type outer case, and an electrolyte solution injected to obtain a coin-type lithium secondary battery. A 1M LiPF₆ solution in a mixed solvent of EC/EMC (25/75; volume ratio) was prepared, and then 1 wt % of vinylene carbonate (VC), 0.5 wt % of 1,3-propensultone (PRS), and 0.5 wt % of lithium bis(oxalato)borate (LiBOB) were added to prepare the electrolyte solution.

### OTHER EXAMPLES AND COMPARATIVE EXAMPLES

A lithium secondary battery was manufactured by the same method as that in Example 1, except that the cathode active material and the conductive materials were changed as shown in Table 3 below.

### Experimental Example

### (1) Measurement of Raman Values of First Cathode Active Material Layer and Second Cathode Active Material Layer

Each of the first cathode active material layer including the first conductive material and the cathode active material according to Table 3, and the second cathode active material layer including the second conductive material and the cathode active material was analyzed using a 532 nm laser Raman spectroscopy to measure a Raman spectrum.

In the Raman spectrum, a maximum value (I_{D}) of a peak intensity measured in a range of 1,350 cm⁻¹ to 1380 cm⁻¹ and a maximum value (I_{G}) of a peak intensity measured in a range of 1,580 cm⁻¹ to 1,600 cm⁻¹ were measured.

In Examples 1, 4, 7 and 10, and Comparative Examples 1, 2, 7 and 8 of Table 3, the second cathode active material layer was formed on the first cathode active material layer to form the cathode. Thereafter, the first cathode active material layer and the second cathode active material layer were separated, and the Raman spectroscopy analysis were performed for each layer.

In other Examples and Comparative Examples, an electrode having the same composition as that of the first cathode active material layer and an electrode having the same composition as that of the second cathode active material layer were each prepared, and then the Raman spectroscopy analysis was performed for each electrode.

Raman R values were calculated according to Equation 1, and the results were shown in Table 3, and the measurement equipment/conditions were the same as those described above.

$$Raman R Value = {I}_{D} / {I}_{G} \qquad [ Equation 1 ]$$

TABLE 3

| | first cathode active material layer | | | second cathode active material layer | | |
|---|---|---|---|---|---|---|
| | | first | | | second | |
| | | active | cathode | | active | cathode |
| | type of | material | active | type of | material | active |
| | first | layer | material | second | layer | material |
| | conductive | (Raman | (except for Li | conductive | (Raman | (except for Li |
| | material | R value) | and oxygen) | material | R value) | and oxygen) |
| Example 1 | Sample 1 | 0.95 | Ni_{0.88}Co_{0.1}Mn_{0.02}/ | Sample 6 | 1.17 | Ni_{0.88}Co_{0.1}Mn_{0.02}/ |
| Example 2 | Sample 2 | 0.96 | single particle | Sample 6 | 1.16 | single particle |
| Example 3 | Sample 3 | 1.02 | | Sample 6 | 1.18 | |
| Example 4 | Sample 1 | 0.89 | | Sample 7 | 1.15 | |
| Example 5 | Sample 1 | 0.90 | | Sample 8 | 1.14 | |
| Example 6 | Sample 1 | 0.91 | Ni_{0.6}Co_{0.13}/ | Sample 6 | 1.21 | Ni_{0.6}Co_{0.1}Mn_{0.3}/ |
| Example 7 | Sample 2 | 0.92 | single particle | Sample 6 | 1.23 | single particle |
| Example 8 | Sample 3 | 1.05 | | Sample 6 | 1.27 | |
| Example 9 | Sample 1 | 0.90 | | Sample 7 | 1.15 | |
| Example 10 | Sample 1 | 0.93 | | Sample 8 | 1.14 | |
| Example 11 | Sample 1 | 0.92 | LNMO | Sample 6 | 1.22 | Ni_{0.6}Co_{0.1}Mn_{0.3}/ |
| | | | (LiNi_{0.75}Mn_{0.25})/ | | | single particle |
| | | | single particle | | | |
| Example 12 | Sample 1 | 0.93 | Ni_{0.6}Co_{0.1}Mn_{0.3}/ | Sample 6 | 1.21 | LNMO |
| | | | single particle | | | (LiNi_{0.75}Mn_{0.25})/ |
| | | | | | | single particle |
| Example 13 | Sample 1 | 0.87 | Ni_{0.88}Co_{0.1}Mn_{0.02}/ | Sample 6 | 1.26 | Ni_{0.88}Co_{0.1}Mn_{0.02}/ |
| | | | secondary particle | | | single particle |
| Example 14 | Sample 1 | 0.89 | Ni_{0.88}Co_{0.1}Mn_{0.02}/ | Sample 6 | 1.23 | Ni_{0.88}Co_{0.1}Mn_{0.02}/ |
| | | | single particle | | | secondary particle |
| Comparative | Sample 4 | 0.19 | Ni_{0.88}Co_{0.1}Mn_{0.02}/ | Sample 6 | 1.21 | Ni_{0.88}Co_{0.1}Mn_{0.02}/ |
| Example 1 | | | single particle | | | single particle |
| Comparative | Sample 5 | 1.14 | | Sample 6 | 1.24 | |
| Example 2 | | | | | | |
| Comparative | Sample 1 | 0.93 | | Sample 9 | 1.64 | |
| Example 3 | | | | | | |
| Comparative | Sample 1 | 0.89 | | Sample 10 | 0.82 | |
| Example 4 | | | | | | |
| Comparative | Sample 4 | 0.18 | Ni_{0.6}Co_{0.1}Mn_{0.3}/ | Sample 6 | 1.27 | Ni_{0.6}Co_{0.1}Mn_{0.3}/ |
| Example 5 | | | single particle | | | single particle |
| Comparative | Sample 5 | 1.14 | | Sample 6 | 1.24 | |
| Example 6 | | | | | | |
| Comparative | Sample 1 | 0.89 | | Sample 9 | 1.58 | |
| Example 7 | | | | | | |
| Comparative | Sample 1 | 0.90 | | Sample 10 | 0.86 | |
| Example 8 | | | | | | |
| Comparative | Sample 1 | 0.93 | Ni_{0.6}Co_{0.1}Mn_{0.3}/ | graphite- | 0.93 | Ni_{0.6}Co_{0.1}Mn_{0.3}/ |
| Example 9 | | | single particle | based | | single particle |
| Comparative | CNT-based | 1.22 | | Sample 6 | 1.19 | |
| Example 10 | | | | | | |

### (2) Measurement of High Temperature (45° C.) Capacity Retention

Charging and discharging were repeatedly performed at 45° C. by 500 cycles with charging (CC-CV, SOC98, 0.05C cut-off) and discharging (CC, SOC4 cut-off) as a single cycle.

A capacity retention was measured by expressing a discharge capacity after 500 cycles as a percentage relative to a discharge capacity after one cycle.

### (3) Measurement of High Temperature (45° C.) Resistance Increase Ratio

Charging and discharging were repeatedly performed at 45° C. by 500 cycles with charging (CC-CV, SOC98, 0.05C cut-off) and discharging (CC, SOC4 cut-off) as a single cycle.

A resistance increase ratio was measured by expressing a resistance after 500 cycles as a percentage relative to a resistance after one cycle.

### (4) Measurement of Rapid Charge Capacity Retention

A cycle of charging the secondary battery at 25° C. for 25 minutes in a range of SOC 10-82% and discharging at 0.3C was repeated 300 times. A discharge capacity retention at the 300th cycle relative to an initial discharge capacity at the 1st cycle was measured as a percentage.

The evaluation results are also shown in Table 4 below.

TABLE 4

| | high temperature | high temperature | rapid charge |
|---|---|---|---|
| | capacity | resistance | capacity |
| | retention | increase ratio | retention |
| | (%) | (%) | (%) |
| Example 1 | 93.1 | 148.2 | 96.9 |
| Example 2 | 92.6 | 152.1 | 95.1 |
| Example 3 | 91.8 | 153.7 | 94.3 |
| Example 4 | 93.4 | 147.6 | 96.6 |
| Example 5 | 92.2 | 148.2 | 95.2 |
| Example 6 | 92.0 | 156.8 | 88.2 |
| Example 7 | 91.6 | 155.0 | 89.2 |
| Example 8 | 91.8 | 155.6 | 89.7 |
| Example 9 | 91.4 | 157.1 | 88.4 |
| Example 10 | 90.8 | 159.9 | 87.6 |
| Example 11 | 90.2 | 163.7 | 89.1 |
| Example 12 | 90.9 | 162.5 | 89.4 |
| Example 13 | 89.2 | 152.1 | 89.4 |
| Example 14 | 88.8 | 153.6 | 89.6 |
| Comparative | 90.4 | 159.2 | 84.2 |
| Example 1 | | | |
| Comparative | 89.4 | 159.0 | 84.6 |
| Example 2 | | | |
| Comparative | 89.5 | 158.8 | 85.1 |
| Example 3 | | | |
| Comparative | 88.8 | 158.7 | 83.8 |
| Example 4 | | | |
| Comparative | 88.2 | 243.5 | 77.2 |
| Example 5 | | | |
| Comparative | 87.1 | 228.7 | 73.4 |
| Example 6 | | | |
| Comparative | 87.4 | 238.4 | 72.2 |
| Example 7 | | | |
| Comparative | 86.7 | 262.4 | 78.1 |
| Example 8 | | | |
| Comparative | 87.2 | 244.6 | — |
| Example 9 | | | (rapid drop after 150 |
| | | | cycles) |
| Comparative | 86.5 | 282.4 | — |
| Example 10 | | | (rapid drop after 70 |
| | | | cycles) |

As shown in Table 4, the secondary battery including the cathode according to embodiments provided improved capacity retention properties and decreased resistance increase ratio. High capacity retention ratios were also maintained in the secondary batteries including the cathodes according to Examples 6 to 12 in which the nickel content was changed.

High temperature resistance increase ratio was relatively increased in the secondary batteries including the cathodes according to Examples 11 and 12 that included LNMO.

In Examples 13 and 14 including the secondary particles instead of the single particle, the high-temperature capacity retention of the secondary battery was relatively reduced.

In Comparative Examples in which the Raman R value included in the first cathode active material layer and/or the second cathode active material layer was not within the predetermined range, the high-temperature capacity retention and the rapid charge capacity retention of the secondary battery were decreased, and the high-temperature resistance increase ratio was increased.

In Comparative Example 9 including the point-type conductive material in the first and second cathode active material layers and Comparative Example 10 including the linear-type conductive material in the first and second cathode active material layers, the capacity retention of the secondary battery was significantly reduced during the rapid charging.

What is claimed is:

1. A cathode for a lithium secondary battery, comprising:
a cathode current collector;
a first cathode active material layer disposed on the cathode current collector and including a first conductive material, wherein a Raman R value according to Equation 1 of the first cathode active material layer is in a range from 0.5 to 1.1; and
a second cathode active material layer disposed on the first cathode active material layer and including a second conductive material, wherein the Raman R value according to Equation 1 of the second cathode active material layer is in a range from 1.05 to 1.5:
$$Raman R Value = {I}_{D} / {I}_{G} \qquad [ Equation 1 ]$$
wherein, in Equation 1, I_{D} is a maximum value of a peak intensity measured in a range of 1,350 cm⁻¹ to 1380 cm⁻¹ in a Raman spectrum of the first anode active material layer or the second anode active material layer, and I_{G} is a maximum value of a peak intensity measured in a range of 1,580 cm⁻¹ to 1600 cm⁻¹ in the Raman spectrum of the first anode active material layer or the second anode active material layer.

2. The cathode for a lithium secondary battery according to claim 1, wherein the first conductive material includes a point-type conductive material.

3. The cathode for a lithium secondary battery of claim 2, wherein the point-type conductive material includes at least one of graphite, carbon black, acetylene black, or ketjen black.

4. The cathode for a lithium secondary battery of claim 1, wherein a content of the first conductive material is in a range from 0.5 wt % to 5 wt % based on a total weight of the first cathode active material layer.

5. The cathode for a lithium secondary battery of claim 2, wherein an average particle diameter (D50) of the point-type conductive material is in a range from 0.01 μm to 4 μm.

6. The cathode for a lithium secondary battery according to claim 1, wherein the second conductive material includes a linear-type conductive material.

7. The cathode for a lithium secondary battery of claim 6, wherein the linear-type conductive material includes at least one of a single-walled carbon nanotube (SWCNT) and a multi-walled carbon nanotube (MWCNT).

8. The cathode for a lithium secondary battery of claim 6, wherein a length of the linear-type conductive material is in a range from 5 μm to 70 μm.

9. The cathode for a lithium secondary battery of claim 1, wherein a content of the second conductive material is in a range from 0.3 wt % to 1.0 wt % based on a total weight of the second cathode active material layer.

10. The cathode for a lithium secondary battery of claim 1, wherein the first cathode active material layer includes a first lithium-nickel metal oxide in a single particle shape, and the second cathode active material layer includes a second lithium-nickel metal oxide in a single particle shape.

11. The cathode for a lithium secondary battery of claim 10, wherein a mole fraction of nickel among metal elements excluding lithium in each of the first lithium-nickel metal oxide and the second lithium-nickel metal oxide is in a range from 0.4 to 0.95.

12. The cathode for a lithium secondary battery of claim 11, wherein a difference between the mole fraction of nickel in the first lithium-nickel metal oxide and the mole fraction of nickel in the second lithium-nickel metal oxide is 0.1 or less.

13. The cathode for a lithium secondary battery of claim 11, wherein at least one of the mole fraction of nickel in the first lithium-nickel metal oxide and the mole fraction of nickel in the second lithium-nickel metal oxide is 0.6 or less.

14. The cathode for a lithium secondary battery of claim 11, wherein each of the first lithium-nickel metal oxide and the second lithium-nickel metal oxide includes cobalt, and a mole fraction of cobalt among metal elements excluding lithium is in a range from 0.05 to 0.4.

15. A lithium secondary battery, comprising:
the cathode for a lithium secondary battery according to claim 1; and
an anode opposing the cathode.
